(19) United States
(12) Patent Application Publication
(10) Pub. No.: US 2012/0224230 A1
(43) Pub. Date: Sep. 6, 2012

(54) WATERMARKING COMPRISING ULTRAVIOLET CURABLE SOLID INKS AND METHODS FOR PRODUCING THE SAME

(75) Inventors: Daryl W. Vanbesien, Burlington (CA); Barkev Keoshkerian, Thornhill (CA); Naveen Chopra, Oakville (CA); Michelle N. Chrétien, Mississauga (CA)

(73) Assignee: XEROX CORPORATION, Norwalk, CT (US)

(21) Appl. No.: 13/040,187

(22) Filed: Mar. 3, 2011

(51) Int. Cl. G06K 15/02

(52) U.S. Cl. 358/3.28

(57) ABSTRACT

The present embodiments relate to a method of watermarking using a curable gel ink, and in particular, the curable gel ink is an ultraviolet (UV) curable gel ink that can be used in digital printing methods such as ink jet printing. The present embodiments provide improved scratch and rub resistance for watermarks formed with the UV curable gel ink formulations.

### BACKGROUND

The present embodiments relate to a method of watermarking using a curable solid ink, and in particular, wherein the curable solid ink is an ultraviolet (UV) curable gel ink that can be used with digital printing methods such as ink jet printing. The present embodiments provide benefits such as improved scratch and rub resistance for watermarks formed with the UV curable gel ink formulations.

A watermark is a recognizable image or pattern on a substrate that appears as various shades of lightness and darkness when viewed by transmitted light or when viewed by reflected light atop a dark background, which are caused by thickness or density variations in the substrate. Watermarking is used in a variety of applications, for example, for copyright control and authentication purposes, and as value-added content in entertainment applications.

Conventional watermarking methods include using physical means such as the dandy roll process or a more complex cylinder mould process. These processes require complex equipment and are time consuming because they must be done separately from the printing of the ink-based image. In addition, because watermarks are typically prepared using a watermark screen or cylinder that has been specifically designed to incorporate a pre-defined watermark into each input image that is processed using the screen, it is difficult to vary the appearance of the watermark on an image and obtain variable data for different printing runs. Moreover, a watermark cannot be easily viewed on an image without the use of special devices, making the fast detection of a watermark for authentication purposes difficult. Thus, applying known coating formulations and methods for watermarking can be inefficient, difficult, and time-consuming and is not desirable for integration with variable-data digital printing.

Thus, it would be particularly useful to provide a manner in which watermarking is performed concurrently with the printing of the ink-based text or images and also with the same machine, thus eliminating the time-consuming process of applying the watermark separately. There is also a need to obtain a watermark that is resistant to scratching, smearing, and chemical tampering. As the use of watermarks has rapidly increased in authentication applications, there is also a need to obtain watermarks that cannot be easily reproduced using conventional reprographic or scanning equipment, making it difficult to counterfeit watermarks.

### SUMMARY

According to embodiments illustrated herein, there is provided a method of watermarking using novel UV gel ink compositions.

In particular, the present embodiments provide a watermark image comprising: a curable solid ink disposed on a substrate. In embodiments, the curable solid ink is an ultraviolet (UV) curable gel ink comprising: a curable wax; one or more monomers; an optional colorant; an amide gellant; and a photoinitiator.

In further embodiments, there is provided an image comprising: a watermark image; and a print image, wherein the watermark image and the print image are both printed with a curable solid ink and both printed with an inkjet printer.

In yet other embodiments, there is provided a method for producing a watermark image, comprising: providing a curable solid ink; applying the curable solid ink to a substrate to form a watermark image over one or more portions of the substrate; and curing the curable solid ink following application by applying an energy source to the curable solid ink.

### BRIEF DESCRIPTION OF THE DRAWINGS

For a better understanding of the present embodiments, reference may be had to the accompanying figures.

FIG. 1A is a photograph showing a watermark printed over a text document (as viewed on a desk under ambient conditions) using the UV gel ink according to the present embodiments;

FIG. 1B is a photograph showing a watermark printed over a text document (as viewed under fluorescent lighting) using the UV gel ink according to the present embodiments;

FIG. 2A is a photograph showing a copy of the watermarked text document of FIGS. 1A and 1B (as viewed on a desk under ambient conditions); and

FIG. 2B is a photograph showing a copy of the watermarked text document of FIGS. 1A and 1B (as viewed on a desk under fluorescent lighting).

### DETAILED DESCRIPTION

In the following description, it is understood that other embodiments may be utilized and structural and operational changes may be made without departure from the scope of the present embodiments disclosed herein.

Described are watermarks comprising UV curable inks and methods of watermarking with a UV curable ink composition. In particular, the watermarks comprise UV curable solid inks. Solid ink compositions are characterized by being solid at room temperature and molten at an elevated temperature at which the molten ink is applied to a substrate. Solid ink compositions have sharp transition phase. These solid ink compositions can be used for ink jet printing. In the present embodiments, the ink composition is comprised of at least one gellant, at least one curable monomer, at least one curable wax and optionally at least one photoinitiator. The ink composition is a radiation curable, particularly a UV curable, composition comprising at least one gellant, at least one curable monomer, at least one curable wax, and optionally at least one photoinitiator. The ink composition may also optionally include a stabilizer, a surfactant, or other additives. The ink composition is desirably substantially free, such as completely free, of colorant.

The ink composition may be applied at temperatures of from about 50° C. to about 120° C., such as from about 70° C. to about 90° C. At application temperatures, the ink composition may have a viscosity of from about 5 to about 16 cPs, such as from about 8 to 13 cPs. Viscosity values set forth herein are obtained using the cone and plate technique, at a shear rate of 1 s⁻¹. The ink compositions are thus well suited for use in devices in which the ink composition can be digitally applied, such as applied via ink jets.

The at least one gellant, or gelling agent, functions at least to increase the viscosity of the ink composition within a desired temperature range. For example, the gellant forms a solid-like gel in the ink composition at temperatures below the gel point of the gellant, for example below the temperature at which the ink composition is applied. For example, the ink composition ranges in viscosity from about 10³ to about 10⁷ cPs, such as from about 10^{3.5} to about 10^{6.5} cPs, in the solid-like phase. The gel phase typically comprises a solid-like phase and a liquid phase in coexistence, wherein the solid-like phase forms a three-dimensional network structure throughout the liquid phase and prevents the liquid phase from flowing at a macroscopic level. The ink composition exhibits a thermally reversible transition between the gel state and the liquid state when the temperature is varied above or below the gel point of the ink composition. This temperature is generally referred to as a sol-gel temperature. This cycle of gel reformation can be repeated a number of times, since the gel is formed by physical, non-covalent interactions between the gelling agent molecules, such as hydrogen bonding, aromatic interactions, ionic bonding, coordination bonding, London dispersion interactions, or the like.

The temperature at which the ink composition is in gel state is, for example, approximately from about 15° C. to about 55° C., such as from about 15° C. to about 50° C. The gel ink composition may liquefy at temperatures of from about 60° C. to about 90° C., such as from about 70° C. to about 85° C. In cooling from the application temperature liquid state to the gel state, the ink composition undergoes a significant viscosity increase. The viscosity increase is at least a three orders of magnitude increase in viscosity, such as at least a four order of magnitude increase in viscosity.

Curable Gellants

The curable phase change ink composition may include at least one gellant.

The organic gellants function to dramatically increase the viscosity of the ink vehicle and ink composition within a desired temperature range. In particular, the gellant forms a semi-solid gel in the ink vehicle at temperatures below the specific temperature at which the ink composition is jetted. The semi-solid gel phase is a physical gel that exists as a dynamic equilibrium comprised of one or more solid gellant molecules and a liquid solvent. The semi-solid gel phase is a dynamic networked assembly of molecular components held together by non-covalent bonding interactions such as hydrogen bonding, Van der Waals interactions, aromatic non-bonding interactions, ionic or coordination bonding, London dispersion forces, and the like, which upon stimulation by physical forces such as temperature or mechanical agitation or chemical forces such as pH or ionic strength, can reversibly transition from liquid to semi-solid state at the macroscopic level. The ink compositions exhibit a thermally reversible transition between the semi-solid gel state and the liquid state when the temperature is varied above or below the gel-phase transition. This reversible cycle of transitioning between semi-solid gel phase and liquid phase can be repeated many times in the ink formulation. Mixtures of one or more gellants may be used to effect the phase change transition.

The phase change nature of the gellant can thus be used to cause a rapid viscosity increase in the jetted ink composition upon the substrate following jetting of the ink to the substrate. In particular, jetted ink droplets would be pinned into position on a receiving substrate, such as an image-receiving medium (for instance, paper), that is at a temperature cooler than the ink-jetting temperature of the ink composition through the action of a phase change transition in which the ink composition undergoes a significant viscosity change from a liquid state to a gel state (or semi-solid state).

In embodiments, the temperature at which the ink composition forms the gel state is any temperature below the jetting temperature of the ink composition, for example any temperature that is about 10° C. or more below the jetting temperature of the ink composition. There is a rapid and large increase in ink viscosity upon cooling from the jetting temperature at which the ink composition is in a liquid state, to the gel transition temperature, at which the ink composition converts to the gel state.

A suitable gellant for the ink composition would gel the monomers/oligomers in the ink vehicle quickly and reversibly, and demonstrate a narrow phase change transition, for example within a temperature range of about 10° C. to about 85° C. The gel state of exemplary ink compositions should exhibit a minimum of 10^{2.5} mPa·s, such as 10³ mPa·s, increase in viscosity at substrate temperatures, for instance, from about 30° C. to about 60° C., compared to the viscosity at the jetting temperature. In particular embodiments, the gellant-containing ink compositions rapidly increase in viscosity within 5° C. to 10° C. below the jetting temperature and ultimately reach a viscosity above 10⁴ times the jetting viscosity, for example about 10⁶ times the jetting viscosity.

Gellants suitable for use in the ink compositions include a curable gellant comprised of a curable amide, a curable polyamide-epoxy acrylate component and a polyamide component, a curable composite gellant comprised of a curable epoxy resin and a polyamide resin, mixtures thereof and the like, as disclosed in U.S. Patent Publication No 2010/0304040 A1, which is hereby incorporated herein by reference in its entirety. Inclusion of the pliant in the composition permits the composition to be applied over a substrate, such as on one or more portions of the substrate and/or on one or more portions of an image previously formed on the substrate, without excessive penetration into the substrate because the viscosity of the composition is quickly increased as the composition cools following application. Excessive penetration of a liquid into a porous substrate, such as paper, can lead to an undesirable decrease in the substrate opacity. The curable gellant may also participate in the curing of monomer(s) of the composition.

The gellants suitable for use in the composition may be amphiphilic in nature in order to improve wetting when the composition is utilized over a substrate having silicone or other oil thereon. Amphiphilic refers to molecules that have both polar and non-polar parts of the molecule. For example, the gellants may have long non-polar hydrocarbon chains and polar amide linkages.

Amide gellants suitable for use include those described in U.S. Pat. Nos. 7,531,582, 7,276,614 and 7,279,587, the entire disclosures of which are incorporated herein by reference. Additional gellants suitable for use also include those described in U.S. patent application Ser. No. 12/765,148 to Chopra et al. filed on Apr. 22, 2010.

As described in U.S. Pat. No. 7,279,587, the amide gellant may be a compound of the formula

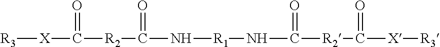

wherein:

### R₁ is:

(i) an alkylene group (wherein an alkylene group is a divalent aliphatic group or alkyl group, including linear and branched, saturated and unsaturated, cyclic and acyclic, and substituted and unsubstituted alkylene groups, and wherein heteroatoms, such as oxygen, nitrogen, sulfur, silicon, phosphorus, boron, and the like either may or may not be present in the alkylene group) having from about 1 carbon atom to about 12 carbon atoms, such as from about 1 carbon atom to about 8 carbon atoms or from about 1 carbon atom to about 5 carbon atoms,
(ii) an arylene group (wherein an arylene group is a divalent aromatic group or aryl group, including substituted and unsubstituted arylene groups, and wherein heteroatoms, such as oxygen, nitrogen, sulfur, silicon, phosphorus, boron, and the like either may or may not be present in the arylene group) having from about 1 carbon atom to about 15 carbon atoms, such as from about 3 carbon atoms to about 10 carbon atoms or from about 5 carbon atoms to about 8 carbon atoms,
(iii) an arylalkylene group (wherein an arylalkylene group is a divalent arylalkyl group, including substituted and unsubstituted arylalkylene groups, wherein the alkyl portion of the arylalkylene group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the arylalkylene group) having from about 6 carbon atoms to about 32 carbon atoms, such as from about 6 carbon atoms to about 22 carbon atoms or from about 6 carbon atoms to about 12 carbon atoms, or
(iv) an alkylarylene group (wherein an alkylarylene group is a divalent alkylaryl group, including substituted and unsubstituted alkylarylene groups, wherein the alkyl portion of the alkylarylene group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the alkylarylene group) having from about 5 carbon atoms to about 32 carbon atoms, such as from about 6 carbon atoms to about 22 carbon atoms or from about 7 carbon atoms to about 15 carbon atoms,
wherein the substituents on the substituted alkylene, arylene, arylalkylene, and alkylarylene groups can be halogen atoms, cyano groups, pyridine groups, pyridinium groups, ether groups, aldehyde groups, ketone groups, ester groups, amide groups, carbonyl groups, thiocarbonyl groups, sulfide groups, nitro groups, nitroso groups, acyl groups, azo groups, urethane groups, urea groups, mixtures thereof, and the like, wherein, two or more substituents can be joined together to form a ring;

R₂ and R₂′ each, independently of the other, are

(i) alkylene groups having from about 1 carbon atom to about 54 carbon atoms, such as from about 1 carbon atom to about 48 carbon atoms or from about 1 carbon atom to about 36 carbon atoms,
(ii) arylene groups having from about 5 carbon, atoms to about 15 carbon atoms, such as from about 5 carbon atoms to about 13 carbon atoms or from about 5 carbon atoms to about 10 carbon atoms,
(iii) arylalkylene groups having from about 6 carbon atoms to about 32 carbon atoms, such as from about 7 carbon atoms to about 33 carbon atoms or from about 8 carbon atoms to about 15 carbon atoms, or
(iv) alkylarylene groups having from about 6 carbon atoms to about 32 carbon atoms, such as from about 6 carbon atoms to about 22 carbon atoms or from about 7 carbon atoms to about 15 carbon atoms,

wherein the substituents on the substituted alkylene, arylene, arylalkylene, and alkylarylene groups may be halogen atoms, cyano groups, ether groups, aldehyde groups, ketone groups, ester groups, amide groups, carbonyl groups, thiocarbonyl groups, phosphine groups, phosphonium groups, phosphate groups, nitrile groups, mercapto groups, nitro groups, nitroso groups, acyl groups, acid anhydride groups, azide groups, azo groups, cyanato groups, urethane groups, urea groups, mixtures thereof, and the like, and wherein two or more substituents may be joined together to form a ring;

R₃ and R₃′ each, independently of the other, are either

(a) photoinitiating groups, such as groups derived from 1-(4-(2-hydroxyethoxy)phenyl)-2-hydroxy-2-methylpropan-1-one, of the formula

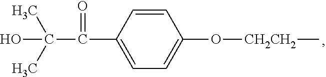

groups derived from 1-hydroxycyclohexylphenylketone, of, the formula

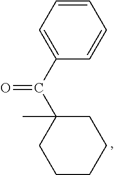

groups derived from 2-hydroxy-2-methyl-1-phenylpropan-1-one, of the formula

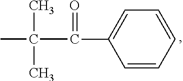

groups derived from N,N-dimethylethanolamine or N,N-dimethylethylenediamine, of the formula

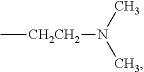

or the like, or:
(b) a group which is
(i) an alkyl group (including linear and branched, saturated and unsaturated, cyclic and acyclic, and substituted and unsubstituted alkyl groups, and wherein heteroatoms, such as oxygen, nitrogen, sulfur, silicon, phosphorus, boron, and the like either may or may not be present in the alkyl group) having from about 2 carbon atoms to about 100 carbon atoms, such as from about 3 carbon atoms to about 60 carbon atoms or from about 4 carbon atoms to about 30 carbon atoms,
(ii) an aryl group (including substituted and unsubstituted aryl groups, and wherein heteroatoms, such as oxygen, nitrogen, sulfur, silicon, phosphorus, boron, and the like either may or may not be present in the aryl group) having from about 5 carbon atoms to about 100 carbon atoms, such as from about 5 carbon atoms to about 60 carbon atoms or from about 6 carbon atoms to about 30 carbon atoms, such as phenyl or the like,
(iii) an arylalkyl group (including substituted and unsubstituted arylalkyl groups, wherein the alkyl portion of the arylalkyl group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the arylalkyl group) having from about 5 carbon atoms to about 100 carbon atoms, such as from about 5 carbon atoms to about 60 carbon atoms or from about 6 carbon atoms to about 30 carbon atoms, such as benzyl or the like, or
(iv) an alkylaryl group (including substituted and unsubstituted alkylaryl groups, wherein the alkyl portion of the alkylaryl group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the alkylaryl group) having from about 5 carbon atoms to about 100 carbon atoms, such as from about 5 carbon atoms to about 60 carbon atoms or from about 6 carbon atoms to about 30 carbon atoms, such as tolyl or the like,

wherein the substituents on the substituted alkyl, arylalkyl, and alkylaryl groups may be halogen atoms, ether groups, aldehyde groups, ketone groups, ester groups, amide groups, carbonyl groups, thiocarbonyl groups, sulfide groups, phosphine groups, phosphonium groups, phosphate groups, nitrite groups, mercapto groups, nitro groups, nitroso groups, acyl groups, acid anhydride groups, azide groups, azo groups, cyanato groups, isocyanato groups, thiocyanato groups, isothiocyanato groups, carboxylate groups, carboxylic acid groups, urethane groups, urea groups, mixtures thereof, and the like, and wherein two or more substituents may be joined together to form a ring; and X and X′ each, independently of the other, is an oxygen atom or a group of the formula —NR₄—, wherein R₄ is:

(i) a hydrogen atom;

(ii) an alkyl group, including linear and branched, saturated and unsaturated, cyclic and acyclic, and substituted and unsubstituted alkyl groups, and wherein heteroatoms either may or may not be present in the alkyl group, having from about 5 carbon atoms to about 100 carbon atoms, such as from about 5 carbon atoms to about 60 carbon atoms or from about 6 carbon atoms to about 30 carbon atoms,

(iii) an aryl group, including substituted and unsubstituted aryl groups, and wherein heteroatoms either may or may not be present in the aryl group, having from about 5 carbon atoms to about 100 carbon atoms, such as from about 5 carbon atoms to about 60 carbon atoms or from about 6 carbon atoms to about 30 carbon atoms,

(iv) an arylalkyl group, including substituted and unsubstituted arylalkyl groups, wherein the alkyl portion of the arylalkyl group may be linear or branched, saturated or unsaturated, and cyclic or acyclic, and wherein heteroatoms either may or may not be present in either the aryl or the alkyl portion of the arylalkyl group, having from about 5 carbon atoms to about 100 carbon atoms, such as from about 5 carbon atoms to about 60 carbon atoms or from about 6 carbon atoms to about 30 carbon atoms, or

(v) an alkylaryl group, including substituted and unsubstituted alkylaryl groups, wherein the alkyl portion of the alkylaryl group can be linear or branched, saturated or unsaturated, and cyclic or acyclic, and wherein heteroatoms either may or may not be present in either the aryl or the alkyl portion of the alkylaryl group, having from about 5 carbon atoms to about 100 carbon atoms, such as from about 5 carbon atoms to about 60 carbon atoms or from about 6 carbon atoms to about 30 carbon atoms,

wherein the substituents on the substituted alkyl, aryl, arylalkyl, and alkylaryl groups may be halogen atoms, ether groups, aldehyde groups, ketone groups, ester groups, amide groups, carbonyl groups, thiocarbonyl groups, sulfate groups, sulfonate groups, sulfonic acid groups, sulfide groups, sulfoxide groups, phosphine groups, phosphonium groups, phosphate groups, nitrite groups, mercapto groups, nitro groups, nitroso groups, sulfone groups, acyl groups, acid anhydride groups, azide groups, azo groups, cyanato groups, isocyanato groups, thiocyanato groups, isothiocyanato groups, carboxylate groups, carboxylic acid groups, urethane groups, urea groups, mixtures thereof, and the like, and wherein two or more substituents may be joined together to form a ring.

Specific suitable substituents and gellants of the above are further set forth in U.S. Pat. Nos. 7,279,587 and 7,276,614, incorporated herein by reference in their entireties, and, thus are not further detailed herein.

In embodiments, the gellant may comprise a mixture comprising:

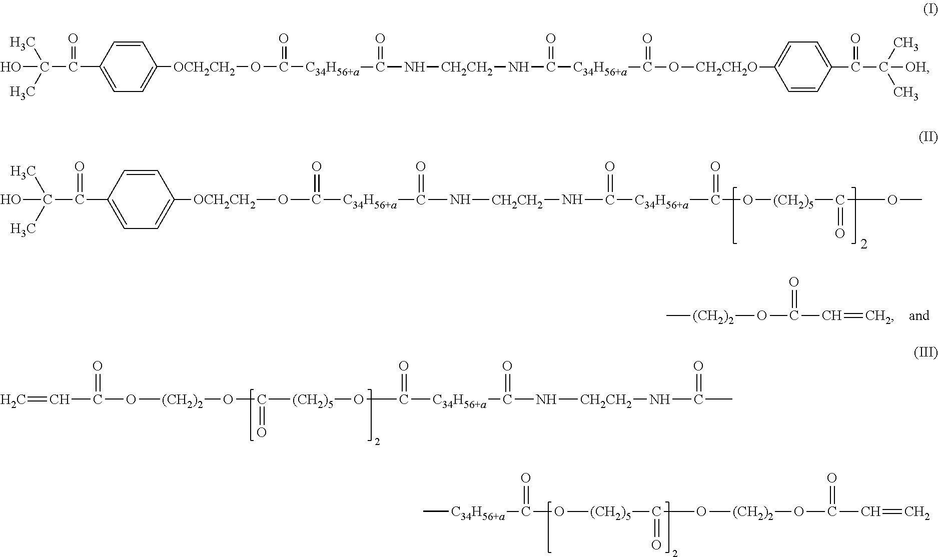

wherein —C₃₄H₅₆₊ₐ— represents a branched alkylene group which may include unsaturations and cyclic groups, wherein the variable “a” is an integer from 0-12.

In embodiments, the gelling agents of the ink may be compounds, as described in U.S. patent application Ser. No. 12/765,148 to Chopra et al., which is hereby incorporated by reference. For example, compounds with the following general structures:

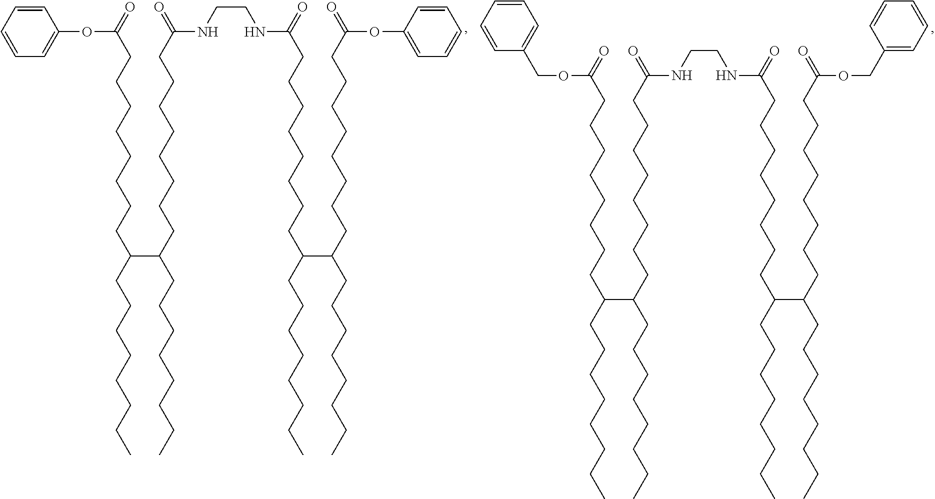

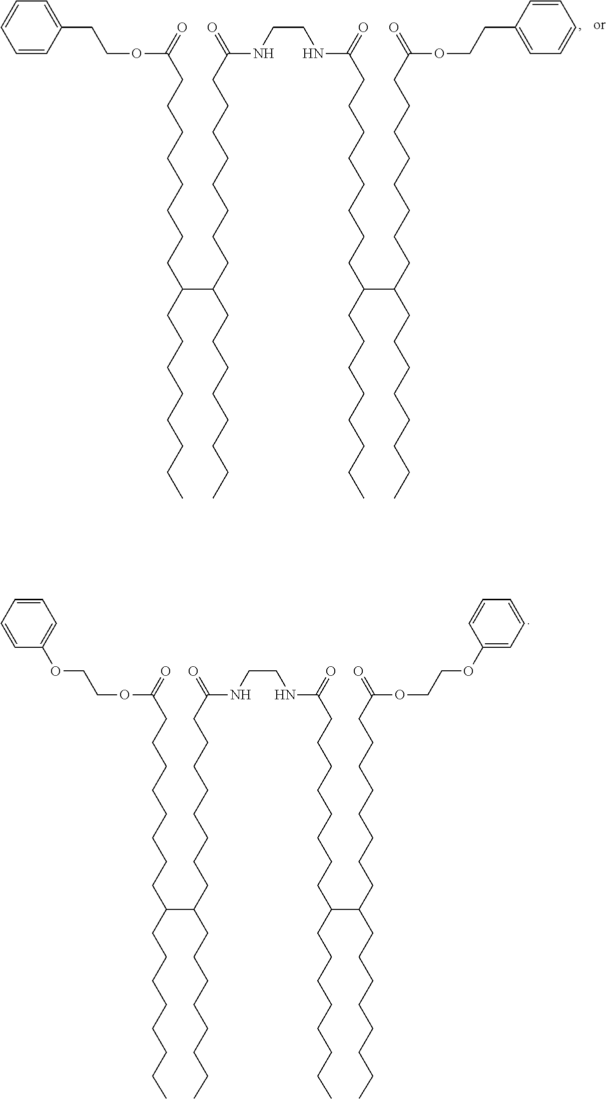

As mentioned above, the ink can include the gelling agent, or gellant, in any suitable amount, such as about 1% to about 30% by weight of the ink, for example in an amount of about 2% to about 20% by weight of the ink, such as about 5% to about 12% by weight of the total ink composition, although the amounts can be outside of these ranges.

The ink composition may include the gellant in any suitable amount, such as about 1% to about 50% by weight of the ink composition. In embodiments, the gellant may be present in an amount of about 2% to about 20% by weight of the ink composition, such as about 3% to about 10% by weight of the ink composition, although the value can also be outside of this range.

Examples of the at least one curable monomer of the ink composition include propoxylated neopentyl glycol diacrylate (such as SR-9003 from Sartomer), diethylene glycol diacrylate, triethylene glycol diacrylate, hexanediol diacrylate, dipropyleneglycol diacrylate, tripropylene glycol diacrylate, alkoxylated neopentyl glycol diacrylate, isodecyl acrylate, tridecyl acrylate, isobornyl acrylate, propoxylated trimethylolpropane triacrylate, ethoxylated trimethylolpropane triacrylate, di-trimethylolpropane tetraacrylate, dipentaerythritol pentaacrylate, ethoxylated pentaerythritol tetraacrylate, propoxylated glycerol triacrylate, isobornyl methacrylate, lauryl acrylate, lauryl methacrylate, neopentyl glycol propoxylate methylether monoacrylate, isodecylmethacrylate, caprolactone acrylate, 2-phenoxyethyl acrylate, isooctylacrylate, isooctylmethacrylate, butyl acrylate, mixtures thereof and the like.

The term “curable monomer” is also intended to encompass curable oligomers, which may also be used in the ink composition. Examples of suitable radiation curable oligomers that may be used in the ink compositions have a low viscosity, for example, from about 50 cPs to about 10,000 cPs, such as from about 75 cPs to about 7,500 cPs or from about 100 cPs to about 5,000 cPs at room temperature. Examples of such oligomers may include CN549, CN131, CN131B, CN2285, CN 3100, CN3105, CN132, CN133, CN 132, available from Sartomer Company, Inc., Exeter, Pa., Ebecryl 140, Ebecryl 1140, Ebecryl 40, Ebecryl 3200, Ebecryl 3201, Ebecryl 3212, available from Cytec Industries Inc, Smyrna Ga., PHOTOMER 3660, PHOTOMER 5006F, PHOTOMER 5429, PHOTOMER 5429F, available from Cognis Corporation, Cincinnati, Ohio, LAROMER PO 33F, LAROMER PO 43F, LAROMER PO 94F, LAROMER UO 35D, LAROMER PA 9039V, LAROMER PO 9026V, LAROMER 8996, LAROMER 8765, LAROMER 8986, available from BASF Corporation, Florham Park, N.J., and the like.

In embodiments, the curable monomer includes both a propoxylated neopentyl glycol diacrylate (such as SR-9003 from Sartomer) and a dipentaerythritol pentaacrylate (such as SR399LV from Sartomer). The inclusion of the pentaacrylate is advantageous in providing more functionality, and thus more reactivity, compared to the diacrylate. However, the amount of the pentaacrylate needs to be limited in the ink composition as too much can adversely affect the viscosity of the composition at application temperatures. The pentaacrylate thus makes up 10% by weight or less of the composition, such as 0.5 to 5% by weight of the composition.

The curable monomer in embodiments is included in the ink composition in an amount of for example, about 20 to about 95% by weight of the ink composition, such as about 40 to about 85% by weight of the ink composition, or about 50 to about 80% by weight of the ink composition.

The ink composition may further include at least one photoinitiator for initiating curing, for example UV curing. Any photoinitiator that absorbs radiation, for example UV light radiation, to initiate curing of the curable components of the formulation may be used, although it is desirable if the photoinitiator does not substantially produce a yellow coloration upon cure.

Examples of free-radical photoinitiators, suitable for use with compositions including acrylates, include benzophenones, benzoin ethers, benzil ketals, α-hydroxyalkylphenones, and acylphosphine photoinitiators, such as sold under the trade designations of IRGACURE and DAROCUR from Ciba. Another suitable photoinitiator for the present embodiments is IRGASTAB UV10 inhibitor also from Ciba. Specific examples of suitable photoinitiators include 2,4,6-trimethylbenzoyldiphenylphosphine oxide (available as BASF LUCIRIN TPO); 2,4,6-trimethylbenzoylethoxyphenylphosphine oxide (available as BASF LUCIRIN TPO-L); bis(2,4,6-trimethylbenzoyl)-phenyl-phosphine oxide (available as Ciba IRGACURE 819) and other acyl phosphines; 2-methyl-1-(4-methylthio)phenyl-2-(4-morphorlinyl)-1-propanone (available as Ciba IRGACURE 907) and 1-(4-(2-hydroxyethoxy)phenyl)-2-hydroxy-2-methylpropan-1-one (available as Ciba IRGACURE 2959); 2-hydroxy-1-(4-(4-(2-hydroxy-2-methylpropionyl)-benzyl)-phenyl)-2-methylpropan-1-one (available as Ciba IRGACURE 127); titanocenes; isopropylthioxanthone (ITX); 1-hydroxy-cyclohexylphenylketone; benzophenone; 2,4,6-trimethylbenzophenone; 4-methylbenzophenone; diphenyl-(2,4,6-trimethylbenzoyl)phosphine oxide; 2,4,6-trimethylbenzoylphenylphosphinic acid ethyl ester; oligo(2-hydroxy-2-methyl-1-(4-(1-methylvinyl)phenyl)propanone); 2-hydroxy-2-methyl-1-phenyl-1-propanone; benzyl-dimethylketal; and mixtures thereof.

An amine synergist, that is, co-initiators that donate a hydrogen atom to a photoinitiator and thereby form a radical species that initiates polymerization (amine synergists can also consume oxygen dissolved in the formulation—as oxygen inhibits free-radical polymerization its consumption increases the speed of polymerization), for example such as ethyl-4-dimethylaminobenzoate and 2-ethylhexyl-4-dimethylaminobenzoate, may also be included.

In embodiments, the photoinitiator package may include at least one alpha-hydroxy ketone photoinitiator and at least one phosphinoyl type photoinitiator(s). One example of the alpha-hydroxy ketone photoinitiator is IRGACURE 127, while one example of the phosphinoyl type photoinitiator is IRGACURE 819, both available from Ciba-Geigy Corp. (Tarrytown, N.Y.). The ratio of the alpha-hydroxy ketone photoinitiator to the phosphinoyl type photoinitiator may be, for example, from about 6 to about 1, such as from about 5 to about 1 or from about 4 to about 1.

The total amount of photoinitiator included in the ink composition may be for example, from about 0.5 to about 15%, such as from about 1 to about 10%, by weight of the ink composition.

The ink composition also includes at least one curable wax. A wax is solid at room temperature, specifically at 25° C. Inclusion of the wax thus may also promote an increase in viscosity of the ink composition as it cools from the application temperature. Thus, the wax may also assist the gellant in avoiding bleeding of the ink composition through the substrate.

The curable wax may be any wax component that is miscible with the other components and that will polymerize with the curable monomer to form a polymer. The term wax includes, for example, any of the various natural, modified natural, and synthetic materials commonly referred to as waxes.

Suitable examples of curable waxes include, but are not limited to, those waxes that include or are functionalized with curable groups. The curable groups may include, for example, acrylate, methacrylate, alkene, allylic ether, epoxide, oxetane, and the like. These waxes can be synthesized by the reaction of a wax equipped with a transformable functional group, such as carboxylic acid or hydroxyl. The curable waxes described herein may be cured with the disclosed monomer(s).

Suitable examples of hydroxyl-terminated polyethylene waxes that may be functionalized with a curable group include, for example, mixtures of carbon chains with the structure CH₃—(CH₂)ₙ—CH₂OH, where there is a mixture of chain lengths, n, where the average chain length can be in the range of about 16 to about 50, and linear low molecular weight polyethylene, of similar average chain length. Suitable examples of such waxes include, for example, the UNILIN® series of materials such, as UNILIN® 350, UNILIN® 425, UNILIN® 550 and UNILIN® 700 with Mₙ approximately equal to 375, 460, 550 and 700 g/mol, respectively. All of these waxes are commercially available from Baker-Petrolite. Guerbet alcohols, characterized as 2,2-dialkyl-1-ethanols, are also suitable compounds. Exemplary Guerbet alcohols include those containing about 16 to about 36 carbons, many of which are commercially available from Jarchem Industries Inc., Newark, N.J. PRIPOL® 2033 as well as other branched isomers that may include unsaturations and cyclic groups, available from Uniqema, New Castle, Del.; further information on C₃₆ dimer diols of this type is disclosed in, for example, “Dimer Acids,” Kirk—Othmer Encyclopedia of Chemical Technology, Vol. 8, 4^{th} Ed. (1992), pp. 223 to 237, the disclosure of which is totally incorporated herein by reference) may also be used. These alcohols can be reacted with carboxylic acids equipped with UV curable moieties to form reactive esters. Examples of these acids include acrylic and methacrylic acids, available from Sigma-Aldrich Co.

Suitable examples of carboxylic acid-terminated polyethylene waxes that may be functionalized with a curable group include mixtures of carbon chains with the structure CH₃—(CH₂)ₙ—COOH, where there is a mixture of chain lengths, n, where the average chain length is about 16 to about 50, and linear low molecular weight polyethylene, of similar average chain length. Suitable examples of such waxes include, but are not limited to, UNICID® 350, UNICID® 425, UNICID® 550 and UNICID® 700 with Mₙ equal to approximately 390, 475, 565 and 720 g/mol, respectively. Other suitable waxes have a structure CH₃—(CH₂)ₙ—COOH, such as hexadecanoic or palmitic acid with n=14, heptadecanoic or margaric or daturic acid with n=15, octadecanoic or stearic acid with n=16, eicosanoic or arachidic acid with n=18, docosanoic or behenic acid with n=20, tetracosanoic or lignoceric acid with n=22, hexacosanoic or cerotic acid with, n=24, heptacosanoic or carboceric acid with n=25, octacosanoic or montanic acid with n=26, triacontanoic or melissic acid with n=28, dotriacontanoic or lacceroic acid with n=30, tritriacontanoic or ceromelissic or psyllic acid, with n=31, tetratriacontanoic or geddic acid with n=32, pentatriacontanoic or ceroplastic acid with n=33. Guerbet acids, characterized as 2,2-dialkyl ethanoic acids, are also suitable compounds. Exemplary Guerbet acids include those containing 16 to 36 carbons, many of which are commercially available from Jarchem Industries Inc., Newark, N.J. PRIPOL® 1009 as well as other branched isomers that may include unsaturations and cyclic groups, available from Uniqema, New Castle, Del.; further information on C₃₆ dimer acids of this type is disclosed in, for example, “Dimer Acids,” Kirk—Othmer Encyclopedia of Chemical Technology, Vol. 8, 4^{th} Ed. (1992), pp. 223 to 237, the disclosure of which is totally incorporated herein by reference) can also be used. These carboxylic acids can be reacted with alcohols equipped with UV curable moieties to form reactive esters. Examples of these alcohols include, but are not limited to, 2-allyloxyethanol from Sigma-Aldrich Co.; SR495B from Sartomer Company, Inc.; and CD572 (R=H, n=10) and SR604 (R=Me (methyl), n=4) from Sartomer Company, Inc.

The curable wax can be included in the ink composition in an amount of from, for example, about 0.1% to about 30% by weight of the ink composition, such as from about 0.5% to about 20% or from about 0.5% to 15% by weight of the ink composition.

The ink composition may also optionally contain an antioxidant stabilizer. The optional antioxidants of the ink compositions protect the images from oxidation and also protect the ink components from oxidation during the heating portion of the ink preparation process. Specific examples of suitable antioxidant stabilizers include NAUGARD™ 524, NAUGARD™ 635, NAUGARD™ A, NAUGARD™ I-403, and NAUGARD™ 959, commercially available from Chemtura, Middlebury, Conn.; IRGANOX™ 1010, and IRGASTAB UV 10, commercially available from BASF; GENORAD 16 and GENORAD 40 commercially available from Rahn A G, Zurich, Switzerland, and the like.

The ink composition may further optionally include conventional additives to take advantage of the known functionality associated with such conventional additives. Such additives may include, for example, defoamers, surfactants, slip and leveling agents, etc.

The ink composition, is substantially colorless. “Substantially colorless” refers to the ink composition being substantially or completely transparent or clear after undergoing curing. For this, the composition may be substantially free of colorants, such as pigments, dyes or mixtures thereof. The ink composition described herein does not yellow upon curing and remains substantially or completely transparent and clear, that is, little or no measurable difference in any of L*a*b* values or k, c, m, y is observed. Being “substantially non-yellowing” or “substantially or completely transparent or clear” refers to the ink composition changing color or hue upon curing in an amount of less than about 15%, such as less than about 10% or less than about 5%, for example about 0%.

In embodiments, the ink composition described herein may be prepared by mixing the curable monomer, curable wax and gellant at a temperature of from about 75° C. to about 150° C., such as from about 80° C. to about 110° C. or from about 75° C. to about 100° C., until homogenous, for example for from about 0.1 hour to about 3 hours, such as about 2 hours. Once the mixture is homogenous, then the photoinitiator may be added. Alternatively, the curable monomer, curable wax, gellant and photoinitiator may be combined immediately.

The ink composition may be applied directly onto the image receiving substrate, and/or may be applied directly onto an image previously formed on the image receiving substrate. In this regard, the ink composition may be applied (1) over portions of (a portion being less than all) or all of at least one printed image formed on the substrate, (2) over one or more portions of the substrate, and over less than all printable portions of the substrate (a printable portion being that portion of a substrate to which a printing device is capable of providing an image), or (3) over substantially all to all printable portions of the substrate.

When the composition is coated onto an image, parts thereof, substrate, and/or parts thereof, it can be applied at different levels of resolution. For example, the composition can be applied at the resolution of the print halftone dot, at the resolution of distinct part(s) of the image, or at a little less resolution than distinct part(s) of the image, allowing for some overlap of the composition onto nonimaged areas of the substrate. The typical composition deposition level is in an amount of from about 5 to about 50 picoliters drop size. The composition can be applied in at least one pass over the image at any stage in the image formation using any known ink jet printing technique, such as, for example, drop-on-demand ink jet printing including, but not limited to, piezoelectric and acoustic ink jet printing.

Following application of the ink composition, the ink composition may then be leveled by contact or non-contact leveling, for example as disclosed in U.S. Patent Publication No. 2009/0195572 A1, and incorporated herein by reference in its entirety.

Following application, the ink is typically cooled to below the gel point of the composition in order to take advantage of the properties of the gelling agent. The composition may then be exposed to radiation (curing energy) to cure the composition. Upon exposure to a suitable source of curing energy, for example, ultraviolet light, electron beam energy, and the like, the photoinitiator absorbs the energy and sets into motion a reaction that converts the gel-like ink composition into a cured protective overcoat. The viscosity of the overcoat composition further increases upon exposure to the suitable source of curing energy, such that it hardens to a solid. The monomer and wax, and optionally the gellant, in the composition contain functional groups that polymerize as a result of the exposure of the photoinitiator to UV light, forming a polymer network. In the absence of photoinitiators these functional groups may polymerize as a result of exposure to e-beam radiation. This polymer network provides printed images with, for example, durability, thermal and light stability, and scratch and smear resistance.

The energy source used to initiate crosslinking of the radiation curable components of the composition can be actinic, for example, radiation having a wavelength in the ultraviolet or visible region of the spectrum, accelerated particles, for example, electron beam radiation, thermal, for example, heat or infrared radiation, or the like. In embodiments, the energy is actinic radiation because such energy provides excellent control over the initiation and rate of crosslinking. Suitable sources of actinic radiation include mercury lamps, xenon lamps, carbon arc lamps, tungsten filament lamps, lasers, light emitting diodes, sunlight, and the like.

Ultraviolet radiation, especially from a medium pressure mercury lamp with a high speed conveyor under UV light, for example, about 20 to about 70 m/min, may be desired, wherein the UV radiation is provided at a wavelength of about 200 to about 500 nm for about less than one second. In embodiments, the speed of the high speed conveyor is about 15 to about 35 m/min under UV light at a wavelength of about 200 to about 450 nm for about 10 to about 50 milliseconds (ms). The emission spectrum of the UV light source generally overlaps the absorption spectrum of the UV-initiator. Optional curing equipment includes, but is not limited to, a reflector to focus or diffuse the UV light, and a cooling system to remove heat from the UV light source.

Any suitable substrate or recording sheet can be employed, including plain papers such as XEROX 4200 papers, XEROX Image Series papers, Courtland 4024 DP paper, ruled notebook paper, bond paper, silica coated papers such as Sharp Company silica coated paper, JuJo paper, HAMMERMILL LASERPRINT paper, and the like, glossy coated papers such as XEROX Digital Color Gloss, Sappi Warren Papers LUSTROGLOSS, specialty papers such as Xerox DURAPAPER, and the like, transparency materials, fabrics, textile products, plastics, polymeric films, inorganic recording mediums such as metals and wood, and the like, transparency materials, fabrics, textile products, plastics, polymeric films, inorganic substrates such as metals and wood, and the like.

When coating a toner-based image, the fused toner-based print is obtained first and then subjected to an ink jet printer containing the ink composition. The toner-based print can be prepared by any suitable conventional xerographic technique or variant thereof.

Similarly, when coating an ink-based image, the ink-based image is generated first and then subjected to an ink jet printer containing the ink composition for the watermark. If the ink-based image is formed using, an ink jet printer, then the ink-based image can be subjected to a separate ink jet printer containing the ink composition for the watermark or the ink jet ink can be housed in, the same ink jet printer as the composition, whereby the composition for the watermark is coated onto the substrate and/or image as a colorless, transparent fluid after the ink jet ink image is formed. When the ink composition for the watermark is coated over an ink-based image, particularly an image produced using an ink jet printer, the image can be prepared by any suitable conventional process or variant thereof.

The disclosure will be illustrated further in the following Example.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

While the description above refers to particular embodiments, it will be understood that many modifications may be made without departing from the spirit thereof. The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

### EXAMPLE

The example set forth herein below is illustrative of the compositions and conditions that can be used in practicing the present embodiments. It will be apparent, however, that the present embodiments can be practiced with many types of compositions and can have many different uses in accordance with the disclosure above and as pointed out hereinafter.

### Example 1

An ink composition for the watermark having the components and amounts set forth in Table 1 was prepared by mixing all of the components together. The solution was heated to 85° C. for one (1) hour. The resulting composition was then filtered though a 1 micron filter.

TABLE 1

| Component | Composition (parts) |
|---|---|
| SR9003 UV monomer | 389 |
| Amide Gellant | 37.5 |
| Acrylated wax | 25 |
| SV399LV UV oligomer | 25 |
| Photoinitiator package: | |
| Irgacure 819 | 5 |
| Irgacure 127 | 17.5 |
| Irgastab UV10 inhibitor | 1 |

The ink composition from Table 1 for the watermark was loaded into one of the color housings of a modified PHASER inkjet printer, in which the term “CONFIDENTIAL” and a design logo was printed over a pre-printed text image. The resultant document was then cured using ultraviolet light. In the text document, the UV gel ink watermark is clearly visible without the use of special viewing equipment (e.g., visible with the human eye under ambient conditions or under light having wavelengths of from about 390 to about 750 nm). The text document was subsequently photocopied using a conventional reprographic machine. Upon photocopying, the watermark was not reproduced in the photocopy of the text document.

### Example 2

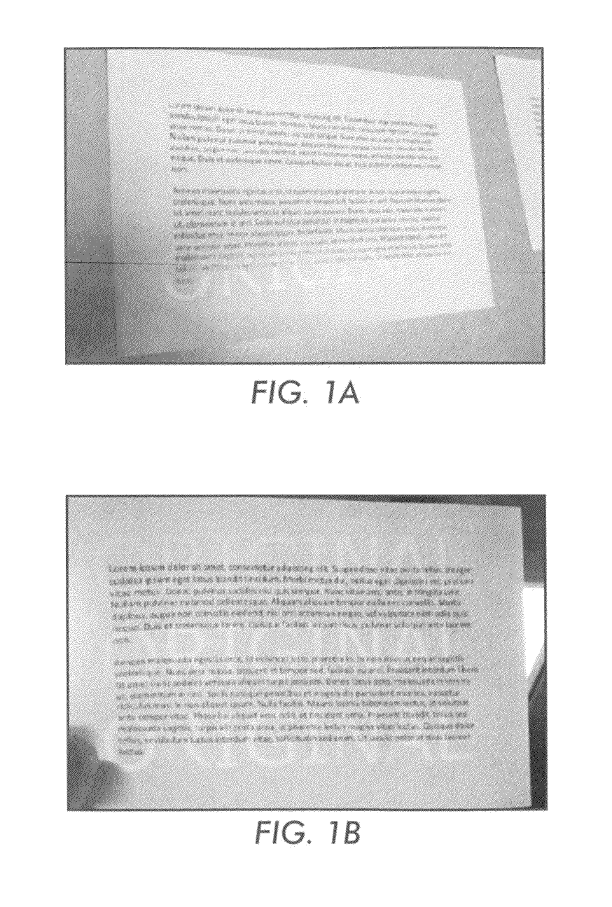

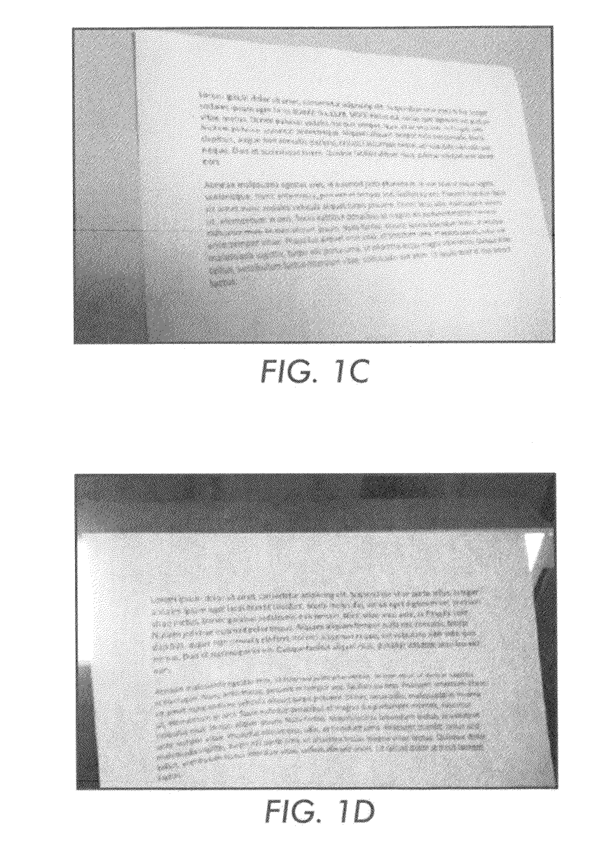

In another example, a text document on coated paper was printed with the term “ORIGINAL” over the text using the UV gel ink of the present embodiments. As shown in FIG. 1A and FIG. 1B, the watermark is seen both when viewed on a desk under ambient conditions or under light having wavelengths of from about 390 to about 750 nm (in this case, fluorescent lighting), respectively. The watermark was not reproduced in a photocopy of the original text document, as shown in FIG. 2A and FIG. 2B on a desk under ambient conditions and held up under fluorescent lighting, respectively.

### SUMMARY

In summary, the present embodiments provide a method for producing a watermark using a UV curable gel ink composition that can be viewed without special viewing devices and cannot be reproduced or altered by conventional scanning or copying. Further, the UV gel ink composition can be used to print a watermark onto an existing document or at the same time (e.g., concurrently or sequentially) as the text image and with the same printer, thus eliminating the need for complex and time-consuming equipment. The UV gel ink composition also renders the watermark resistant to scratching, smearing, and chemical tampering which is present in watermarks produced by conventional watermarking methods.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

All the patents and applications referred to herein are hereby specifically, and totally incorporated herein by reference in their entirety in the instant specification.

What is claimed is:

1. A watermark image comprising:
a curable solid ink disposed on a substrate.

2. The watermark image of claim 1, wherein the curable solid ink is an ultraviolet (UV) curable gel ink comprising:
a curable wax;
one or more monomers;
an optional colorant;
an amide gellant; and
a photoinitiator.

3. The watermark image of claim 1, wherein the substrate is selected from the group consisting of plain paper, ruled notebook paper, bond paper, silica coated paper, glossy coated paper, transparency materials, fabrics, textile products, plastics, polymeric films, metal, and wood.

4. The watermark image of claim 1 being applied to the print substrate by an inkjet printer.

5. The watermark image of claim 2, wherein the at least one curable wax is selected from the group consisting of acrylate modified hydroxyl-terminated polyethylene wax, behenyl acrylate, octadecyl acrylate, acrylated C₁₂ linear alcohols, and mixtures thereof.

6. The watermark image of claim 2, wherein the one or more monomers is selected from the group consisting of propoxylated neopentyl glycol diacrylate, diethylene glycol diacrylate, triethylene glycol diacrylate, hexanediol diacrylate, dipropyleneglycol diacrylate, tripropylene glycol diacrylate, alkoxylated neopentyl glycol diacrylate, isodecyl acrylate, tridecyl acrylate, isobornyl acrylate, propoxylated trimethylolpropane triacrylate, ethoxylated trimethylolpropane triacrylate, di-trimethylolpropane tetraacrylate, dipentaerythritol pentaacrylate, ethoxylated pentaerythritol tetraacrylate, isobornyl methacrylate, lauryl acrylate, lauryl methacrylate, isodecylmethacrylate, propoxylated glycerol triacrylate, lauryl acrylate, neopentyl glycol propoxylate methylether monoacrylate, caprolactone acrylate, 2-phenoxyethyl acrylate, isooctylacrylate, isooctylmethacrylate, butyl acrylate, and mixtures thereof, and wherein the at least one gellant comprises at least one amide gellant.

7. The watermark image of claim 2, wherein the amide gellant is a phenyl glycol capped amide gellant.

8. The watermark image of claim 2, wherein the photoinitiator is selected from the group consisting of alpha-hydroxy ketones, mono-acyl phosphine oxides, bis-acyl phosphine oxides, and the like, and mixtures thereof.

9. The watermark image of claim 2, wherein the curable solid ink is colorless and substantially free of colorant.

10. The watermark image of claim 2, wherein the optional colorant is selected from the group consisting of a pigment, dye or mixtures thereof.

11. The watermark image of claim 1 being visible in light having wavelengths of from about 390 to about 750 nm.

12. The watermark image of claim 1 being not reproducible through a photocopy.

13. An image comprising:
a watermark image; and
a print image, wherein the watermark image and the print image are both printed with a curable solid ink and both printed with an inkjet printer.

14. The image of claim 13, wherein the watermark image and the print image are printed concurrently or sequentially.

15. The image of claim 13, wherein the curable solid ink is an ultraviolet (UV) curable gel ink comprising:
a curable wax;
one or more monomers;
an optional colorant;
an amide gellant; and
a photoinitiator.

16. A method for producing a watermark image, comprising:
providing a curable solid ink;
applying the curable solid ink to a substrate to form a watermark image over one or more portions of the substrate; and
curing the curable solid ink following application by applying an energy source to the curable solid ink.

17. The method of claim 16, wherein the curable solid ink is an ultraviolet (UV) curable gel ink comprising:
a curable wax;
one or more monomers;
an optional colorant;
an amide gellant; and
a photoinitiator.

18. The method of claim 16, wherein the energy source is radiation having a wavelength in the ultraviolet or visible spectrum.

19. The method of claim 16, wherein applying the curable solid ink to the substrate is performed by an inkjet printer.

20. The method of claim 16, wherein the curable solid ink is cured at a temperature of from about 25° C. to about 80° C. and for about 0.1 seconds to about 2 seconds.
